(19) United States
(12) Patent Application Publication
(10) Pub. No.: US 2003/0000240 A1
(43) Pub. Date: Jan. 2, 2003

(54) Compact countertop frozen food and beverage system for domestic use

(76) Inventor: Richard Charles Pahl, St. Petersburg, FL (US)

Correspondence Address: DOROTHY S. MORSE, ESQ., 515 PARK DRIVE, N.W., BRADENTON, FL, 34209-1847, US

(21) Appl. No.: 10/228,421

(22) Filed: Aug. 27, 2002

Related U.S. Application Data
(63) Continuation-in-part of application No. 09/948,347, filed on Sep. 7, 2001, now Pat. No. 6,438,987.
Application No. 09/948,347 is a continuation-in-part of application No. 09/896,706, filed on Jun. 29, 2001, now Pat. No. 6,390,156.

(51) Int. Cl. A23G 9/00; F25C 1/14; B67D 5/62

(52) U.S. Cl. 62/389; 62/342; 62/354

(57) ABSTRACT

A compact portable, self-contained and self-cleaning, domestic frozen food and beverage system capable of rapidly and automatically preparing and dispensing soft ice cream products, slush drinks, and frozen beverages in an efficient manner. Ingredients are preferably transferred spill-free into the freezing chamber via a paired bottle cap and receptacle that block ingredient transfer unless the bottle cap is securely seated within the receptacle. To begin the freezing process, a user would simply select and depress the start button corresponding to the type of product desired. An inlet port or ports allowing for pressurized fluid flow evenly about the freezing chamber and a rotating auger member disposed within the freezing chamber help the present invention to achieve a rapidly frozen product. Once operation begins, a microprocessor controls the temperature and speed of ingredient mixing with automatic shut-down occurring when auger torque indicates that the product has reached the desired consistency.

### CROSS-REFERENCE TO RELATED APPLICATIONS

This is a continuation-in-part of U.S. patent application Ser. No. 09/948,347, filed Sep. 7, 2001, by the same inventor with the same title, which is a continuation-in-part patent application based upon U.S. patent application Ser. No. 09/896,706 filed on Jun. 29, 2001, in the name of co-inventors Michael Hetherington and Richard C. Pahl. The applicant herein requests all benefit to which he is entitled from the above-identified parent applications.

### BACKGROUND

1. Field of Invention

This invention relates to the field of soft ice cream freezers, and frozen beverage dispensers, specifically to a small and portable, self-contained, self-cleaning domestic frozen food and beverage system having the capability of preparing and dispensing soft ice cream products, frozen yogurt products, milk shakes, slush drinks, and other smooth frozen foods and beverages automatically, in a short period of time, typically less than fifteen minutes. Preferably, transfer of unfrozen ingredients into the system, as well as dispensing of frozen product therefrom, would be performed in an efficient and spill-free manner. One preferred embodiment would allow a user to simply transfer ingredients for the desired product from a holding container with a specifically configured bottle cap into a paired receptacle communicating with the thermally conductive freezing chamber, the paired bottle cap and receptacle causing transfer of ingredients to be blocked until the bottle cap is securely seated within the receptacle. Ingredient flow is again blocked as soon as the bottle cap begins to be drawn away from the receptacle, thus avoiding the opportunity for any spills. In addition to being spill-free, ingredient transfer using such a bottle cap and paired receptacle into the freezing chamber would also be made hands-free. Once the correct amount of the desired ingredients has been transferred into the freezing chamber of the present invention, and since it is a fully integrated, automated, programmable machine, to begin the freezing process a user would simply select and depress the start button corresponding to the type of product desired. An inlet port or several inlet ports evenly disposed about the freezing chamber to introduce fluid flow under pressure around the outside of the freezing chamber for maintaining a substantially uniform temperature therein as well as an auger member disposed within the freezing chamber in a position to rotate about its longitudinal axis in a first direction while concurrently rotating about the longitudinal axis of the freezing chamber in a second direction that is substantially opposite to the first rotational direction, help the present invention to achieve a rapidly frozen product, typically within a time period of less than 15 minutes. Once operation begins, a microprocessor within the housing controls the temperature and speed of ingredient mixing until auger torque indicates that the product has reached the consistency desired, whereafter the system automatically shuts itself off after sending a signal to the user that the partially frozen product is ready for consumption.

2. Description of Related Art

There have been many ice cream freezers designed for domestic use. Some prior art ice cream freezers contemplate a thermally conductive freezing chamber that is removably placed within an insulated outer housing filled with freezing agent during an initial cooling phase, during which the product within the freezing chamber is thoroughly mixed, with the freezing chamber being placed into the freezer portion of a refrigerator after the initial cooling phase for product storage until use. Others contemplate the use of a freezing agent being routed through coils placed in contact with the thermally conductive freezing chamber. Most can be messy to use, and/or awkward or cumbersome to clean after use. While in U.S. Pat. No. 5,845,512 and in U.S. Pat. No. 5,617,734 the inventor herein has been one of several co-inventors previously disclosing a freezing chamber having a plurality of inlet ports and the use of an auger member with concurrently opposing dual rotational means to produce a soft frozen food product, there is no prior art known that discloses a compact and easily portable, self-contained, self-cleaning, fully integrated, automated and programmable domestic frozen food and beverage system with all of the features and advantages of the present invention, including the capability of preparing and dispensing soft ice cream products, frozen yogurt products, milk shakes, slush drinks, and other types of frozen food and beverage products automatically, in a short period of time, and in a neat and efficient manner.

### BRIEF SUMMARY OF THE INVENTION

The primary object of this invention is to provide a compact, self-contained domestic freezing and dispensing system for countertop use that can chill foods and beverages to a desired temperature and consistency in a short period of time. A further object of this invention is to provide a freezing and dispensing system that is efficient and easy to use. It is also the object of this invention to provide a freezing and dispensing system that creates partially frozen food and beverage products automatically and without a mess. It is a further object of this invention to provide a freezing and dispensing system that is compact in configuration for countertop use, sufficiently lightweight so as to be easily portable, and aesthetically pleasing in design. It is also an object of this invention to provide a freezing and dispensing system that is self-cleaning after use. It is a further object of this invention to provide a freezing and dispensing system that allows for spill-free introduction of product ingredients into its freezing chamber. It is also an object of this invention to provide a freezing and dispensing system with which a user can produce a wide variety of partially frozen food and beverage products.

As described herein, properly manufactured and used, the frozen food and beverage preparation and dispensing system of the present invention is a fully integrated, automated, and programmable machine that is small, compact, and easily portable, and allows domestic users to make smooth frozen foods and beverages rapidly and without a mess. In 15 minutes or less, while using the most preferred embodiment of the present invention system, a user could have soft ice cream, frozen yogurt, a milk shake, or a slush drink, simply by 1) adding a prepackaged mix into the system though a dispensing bottle cap and receptacle combination that prevents ingredient flow until the dispensing bottle cap is fully seated within the receptacle, 2) discarding the dispensing container in an appropriate waste receptacle, 3) selecting one of several touch keys or buttons that corresponds to the desired final consistency of the intended product, and when the system signals to a user that the product is finished 4) selecting the touch key or button that will cause the soft frozen product to be dispensed. When the ‘Dispense’ mode is used, the auger operates at a higher speed to push frozen product, or cleaning solution, beyond the pattern cap attached to the dispensing head. Clean up after use is also automated, fast, and efficient. The user simple adds a cleaning solution, sanitizing solution, or water instead of food product ingredients, and then selects the touch key or button indicating a ‘wash’ or ‘cleaning cycle’. The auger speed will increase beyond that routinely used to make a food or beverage product, and agitate the water or solutions within the inner tube of the freezing chamber to thoroughly and expeditiously clean the inside surfaces of the freezing chamber. Once the cleaning cycle is complete, audible and/or visual signals are produced to signal the user that the cleaning process is done, after which the user would need to select the ‘Dispense’ touch key or button that will eject the cleaning solution from the system. The present invention is sufficiently compact in configuration and light in weight, so as to be easily moved from one place to another in a domestic kitchen or in a small eatery. It is self-contained, the user cannot check on the product part way though the freezing process except by disconnection of the system from its available power source, and the user is not required to separate components prior to cleaning it as the cleaning cycle is fully automatic. It is also versatile since it can produce a wide variety of food and beverage products, and since it can create consistent and desirable products in a short period of time and is so easy to use, a person preparing a meal could potentially prepare several frozen food products freshly made for guests in the no more time than it would take to prepare the main course. Since the present invention is fully automated and run by the touch of one button or key, it is simple enough for children to use, even younger children as long as adult supervision is nearby. It also uses a paired dispensing cap and receptacle that together prevent dispensing unless the dispensing cap is fully seated within the receptacle, preventing any mess. Even when one attempts to lift the dispensing cap from the receptacle after ingredient transfer into the receptacle, disconnection is spill-free as ingredient transfer is blocked again once the cap member begins to be lifted away from the receptacle. As an added convenience, when a bayonet turn is applied to the dispensing cap during the time it is seated within the receptacle, the cap member becomes locked within the receptacle and ingredient transfer can be hands-free. Also, the auger has a particular configuration and mixing action that is efficient in preparing a soft frozen product, and the freezing chamber has a configuration incorporating a thermally conductive inner tube and an non-conductive outer tube which together form a sealed chamber through which coolant can be dispersed evenly around the inner tube, allowing for rapid cooling of any food product being mixed within the inner tube. An inlet port, or several inlet ports evenly disposed about the freezing chamber, would introduce fluid flow under pressure around the outside of the freezing chamber for maintaining a substantially uniform temperature therein. Also, in addition to its other features, its compact self-contained design is attractive and allows for convenient dispensing of the product. No domestic ice creamer making or frozen beverage-dispensing device is known with all of the features and advantages of the present invention.

The description herein provides preferred embodiments of the present invention but should not be construed as limiting the scope of the fully integrated, automated, programmable machine herein for preparing and dispensing smooth frozen foods and beverages. For example, variations in the number of inlet ports used in its freezing chamber; the positioning of components within the chassis; the type of materials used for the chassis, outer housing, front cover, and dispensing head assembly; the manner of spill-free ingredient introduction into the freezing chamber, and the size of the receptacle and paired bottle cap, when used; other than those shown and described herein may be incorporated into the present invention. Thus, the scope of the present invention should be determined by the appended claims and their legal equivalents, rather than being limited to the examples given herein.

### BRIEF DESCRIPTION OF THE SEVERAL VIEWS OF THE DRAWINGS

FIG. 1 is an exploded view of the most preferred embodiment of the present invention with its removable front cover poised in a position for attachment over the dispensing head assembly, a receptacle positioned within the top surface of its housing for adding unfrozen food and beverage ingredients, a dispensing recess positioned through the front of the housing beneath the pattern cap attached to and extending below the dispensing head assembly, and touch key controls through the front of the housing beside the dispensing recess.

FIG. 2 is a sectional side view of the freezing chamber of the most preferred embodiment of the present invention with large arrows showing ingredient flow through a feed tube elbow that would be connected by tubing to the receptacle in FIG. 1, the ingredients going through the inner tube, an outer tube surrounding the central portion of the inner tube, two supply fittings for coolant being near to the dispensing end of the inner tube and a return fitting for coolant being positioned near to the feed tube elbow end of the inner tube, and small arrows showing flow of coolant between the inner tube and the outer tube, with o-rings creating an air-tight seal between the inner tube and the outer tube, and ducting creating turbulence in coolant flow to enhance flow density and effect faster cooling of ingredients within the thermally conductive innertube.

FIG. 3 is a side view of the auger assembly in the most preferred embodiment of the present invention with a main shaft substantially parallel to an auger shaft having an auger blade, a front wiper on one end of the auger shaft and a rear wiper near to the opposing end of the wiper shaft, and with a gear and drive shaft used for rotational connection to an auger motor, shown in FIG. 6.

FIG. 4 is a side view of the dispensing head assembly of the most preferred embodiment of the present invention having a front portion and a rear portion, with a pattern cap extending below the front portion of the dispensing assembly.

FIG. 5 is a rear view of the preferred embodiment of the dispensing head assembly of the present invention having a centrally positioned shut-off member secured against the rear surface of the front dispensing head portion by a seal plate and a seal ring.

FIG. 6 is an exploded view of the freezing chamber and auger motor of the most preferred embodiment of present invention with a motor bracket connected to the auger motor and having an opening that allows a drive shaft adapter to connect to the auger assembly drive shaft when positioned within the freezing chamber.

FIG. 7 is a sectional side view of the most preferred embodiment of the present invention having a chassis, the freezing chamber supported within the chassis, the front cover positioned over the dispensing head, and a condenser and fan located within the chassis near to the auger motor.

FIG. 8 is a side view of the most preferred embodiment of the present invention having a chassis, the freezing chamber supported within the chassis and connected to the auger motor, a solenoid supported within the chassis adjacent to the freezing chamber, the dispensing recess connected to the chassis, and a solenoid control positioned through the chassis below the solenoid and adjacent to the dispensing recess.

FIG. 9 is a side view of the most preferred embodiment of the present invention having a chassis, the freezing chamber supported within the chassis and connected to the auger motor, a compressor secured within the chassis below the freezing chamber with the return fitting attached to the freezing chamber being connected to the compressor, a power cord connected through the chassis to the transformer, feet attached to the bottom surface of the chassis, and a fan and condenser positioned within the chassis above the transformer and adjacent to the auger motor.

FIG. 10 is a side view of the most preferred embodiment of the present invention having a chassis, a compressor mounted within the chassis, the fan and condenser mounted within the upper rear portion of the chassis, a power cord attached through the chassis, a printed circuit board positioned within the chassis adjacent to the compressor, a solenoid control secured through the chassis adjacent to printed circuit board, and the solenoid positioned above the solenoid control.

FIG. 11 is a side view of the most preferred embodiment of the present invention having a chassis, a compressor mounted within the chassis, the fan and condenser mounted within the upper rear portion of the chassis, the solenoid and solenoid control being mounted within the front portion of the chassis, and supply tubing for transfer of ingredient to the inner tube.

FIG. 12 is a sectional side view of the most preferred embodiment of the present invention dispensing bottle cap assembly having a bottle cap member, a spring housing attached to the sealed end of the bottle cap member, a valve closure member seated upon the spring housing with an activation pin inserted through an upper central opening in the spring housing, a disk-like spring nut positioned at the lower open end of the spring housing, and a spring positioned within the spring housing between the spring nut and the central opening in the upper end of the spring housing, with an inverted bottle in broken lines having a neck opening with external threads and being used to show the bottle cap assembly in use prior to connection with its paired receptacle.

FIG. 13 is a sectional side view of the most preferred embodiment of the present invention receptacle having a substantially cylindrical housing with a radially extending flange depending from its upper opening, attachment pins downwardly depending from the flange, several stepped interior walls, a substantially rectangular-shaped protrusion attached to the inside wall surface of the housing, a bottom discharge opening, an upwardly tapering spring nut engagement member secured within the discharge opening that has an upper surface configured for partial insertion through the cutout pattern in the spring nut, and also having a dust cap sealing the upper opening in its housing.

FIG. 14 is a perspective top view of the most preferred embodiment of the present invention bottle cap member having a ribbed outer surface, a spirally threaded inner surface, a central spring housing upwardly depending from its lower sealed end, a bottom rim, a side channel adjacent to and above the bottom rim, a notch through the bottom rim, with its spring housing also having a central aperture through its top surface, several slots through its outside surface, and a small hole at the lower end of each slot.

FIG. 15 is a perspective bottom view of the preferred embodiment of the present invention bottle cap member having a ribbed outer surface, a bottom rim, a side channel adjacent to and above the bottom rim, two opposing notches through the bottom rim, and a stop positioned within the channel centrally between the notches, with the tip of the activation pin attached to the spring-biased valve closure member centrally visible through the bottom of the bottle cap member, the disk-like spring nut visible around the activation pin, and the small holes at the lower end of the slot in the spring housing being visible around the spring nut.

FIG. 16 is a perspective side view of the preferred embodiment of the present invention spring-biased valve closure member having a cylindrical main body with an upper closed end and a bottom open end, a downwardly curved flange extending from its open end, and a central activation pin downwardly depending from the upper closed end in a position extending below the outer edge of the flange.

FIG. 17 is a top view of the preferred embodiment of the present invention spring nut having a central cutout pattern comprised of a round hole intersecting an X-shaped opening wherein the length of each arm member of the X-shaped opening is approximately twice that of the diameter dimension of the round hole.

FIG. 18 is a perspective side view of the preferred embodiment of the present invention coil spring having a substantially uniform diameter dimension and uniformly spaced apart coils.

FIG. 19 is a sectional side view of the preferred embodiment of the present invention bottle cap system having a dispensing bottle cap assembly connected to its paired receptacle, with the bottle cap assembly having a bottle cap member, a spring housing attached to the sealed end of the bottle cap member, a spring-biased valve closure member seated upon the spring housing with an activation pin inserted through an upper opening in the spring housing and the valve closure member positioned so as to prevent material transfer, and the bottle cap assembly also having a disk-like spring nut attached to the lower end of the spring, with the targeted docking station receptacle having a housing with an upper flange, attachment pins downwardly depending from the flange, a bottom discharge opening, and an upwardly tapering spring nut engagement member within the discharge opening and having an upper surface configured for insertion through the cutout pattern in the spring nut, and the bottle cap system also having a dust cap employed for sealing the upper opening in the receptacle housing between material transfers with the dust cap being attached to the flange but in an unsealed position.

FIG. 20 is a sectional side view of the preferred embodiment of the present invention bottle cap system with the spring-biased valve closure member raised into an open position allowing material transfer, with the broken lines showing the anticipated direction of material flow.

### DETAILED DESCRIPTION OF THE INVENTION

The present invention 2 comprises a small and portable, self-contained, self-cleaning domestic frozen food and beverage system having the capability of preparing and dispensing soft ice cream products, frozen yogurt products, milk shakes, slush drinks, and other smooth frozen foods and beverages (not shown) automatically, in a short period of time, and in an efficient manner. A user would simply transfer ingredients (not shown) for the desired product through an opening in housing 4 that communicates with a thermally conductive freezing chamber 22. For spill-free operation, a receptacle 8 would communicate with the opening in housing 4 leading to freezing chamber 22, and the system would include bottle cap member 114 configured for pairing with receptacle 8 so that transfer of ingredients is blocked until bottle cap member 114 is securely seated within receptacle 8. Ingredient flow is again blocked as soon as bottle cap member 114 begins to be drawn away from receptacle 8, thus avoiding the opportunity for any spills. In addition to being spill-free, ingredient transfer into the freezing chamber 22 in the most preferred embodiment of the present invention can also be made hands-free once bottle cap member 114 is securely seated and locked into receptacle 8. After the correct amount of the desired ingredients has been transferred into the freezing chamber 22 of the present invention, and since it is a fully integrated, automated, and programmable machine, to begin the freezing process a user would simply select and depress the one of the touch key controls 20 corresponding to the type of product desired. An inlet port or several inlet ports, such as supply fittings 30, evenly disposed about the freezing chamber to introduce fluid flow under pressure around the outside of the freezing chamber 22 for maintaining a substantially uniform temperature therein as well as an auger member, such as auger assembly 40, disposed within the freezing chamber 22 in a position to rotate about its longitudinal axis in a first direction while concurrently rotating about the longitudinal axis of the freezing chamber 22 in a second direction that is substantially opposite to the first rotational direction, help the present invention to achieve a rapidly frozen product, typically within a time period of less than 15 minutes. Once operation begins, a microprocessor, such as printed circuit board 172, within housing 4 controls the temperature and speed of ingredient mixing until auger torque indicates that the product has reached the consistency desired, whereafter the system automatically shuts itself off after sending a signal to the user that the partially frozen product is ready for consumption.

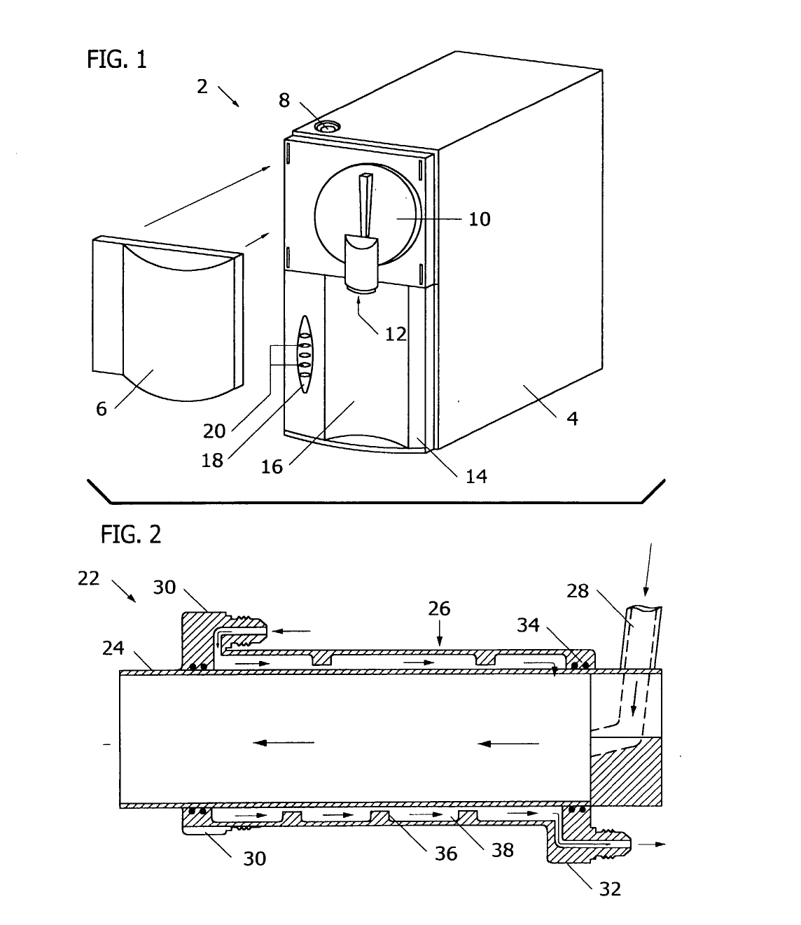

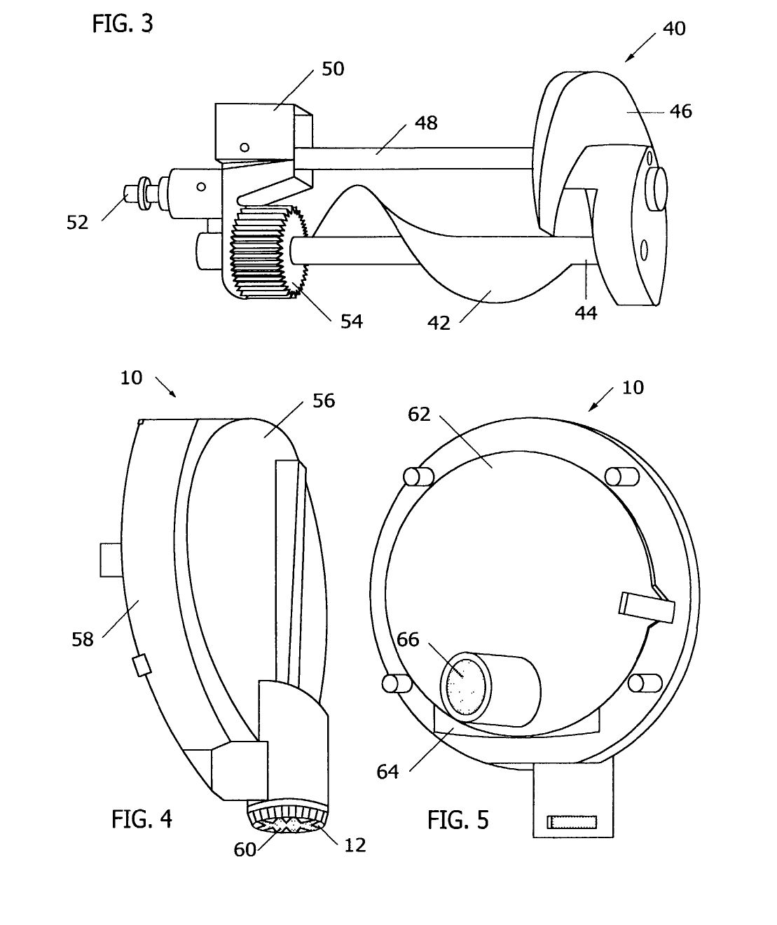

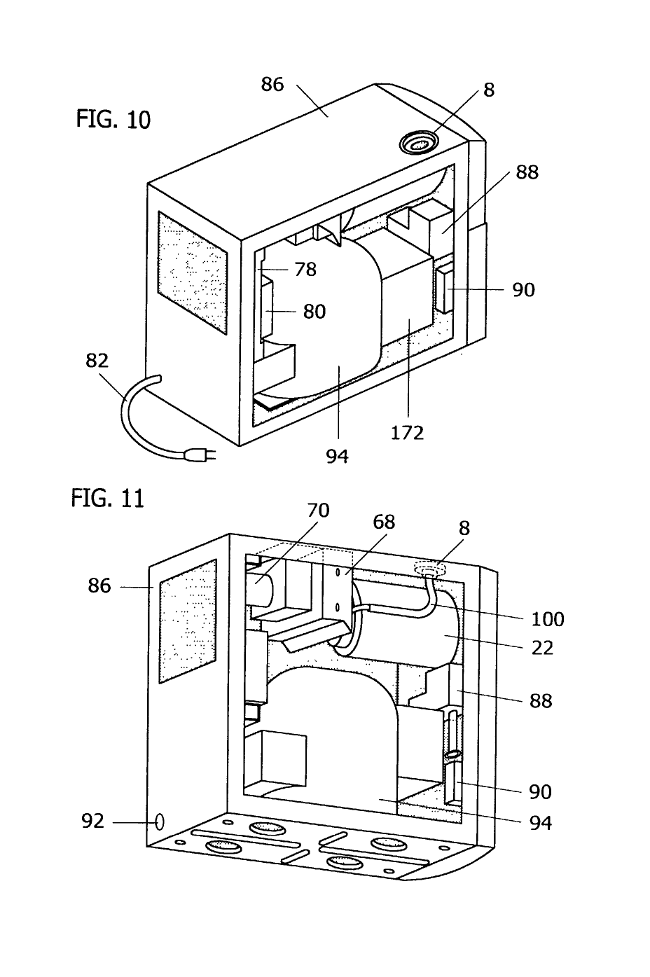

FIG. 1 shows the most preferred embodiment of present invention 2 with its removable front cover 6 poised in a position for attachment over the dispensing head assembly 10, a receptacle 8 positioned within the top surface of its housing 4 for adding unfrozen food and beverage ingredients (not shown) to its freezing chamber shown in FIG. 3 by the number 22, a dispensing recess 16 positioned through the front wall 14 of housing 4 beneath the pattern cap 12 attached to and extending below dispensing head assembly 10, and a control panel 18 of touch key controls 20 through the front of housing 4 to one side of dispensing recess 16. Cover 6 is removable for access to dispensing assembly 10. However, for routine use present invention 2 is self-contained and automated, requiring little maintenance other than the addition of food and beverage ingredients through receptacle 8 and the initiation of an automated cleaning cycle when needed between production of different types of consumable products (not shown). Dispensing recess 16 is configured to allow a user to insert a cup or other container (not shown) beneath pattern cap 12 as a consumable product is being dispensed. Although not limited to such language, in the most preferred embodiment of the present invention touch key controls 20 would be entitled “SOFT SERVE”, “SLUSH”, “MILK SHAKE”, “WASH”, AND “DISPENSE”. Each touch key control 20 would engage the printed circuit board 172 shown in FIG. 10 to control the mixing and cooling of ingredients (not shown) introduced into freezing chamber 22 by way of receptacle 8 at different predetermined speeds and targeted temperatures.

FIG. 2 shows the freezing chamber 22 of the most preferred embodiment of present invention 2 with large arrows showing ingredient flow through a feed tube elbow 28 that would be connected by tubing (shown by the number 100 in FIG. 11) to the receptacle 8 in FIG. 1, the ingredients moving through inner tube 24, an outer tube 26 surrounding the central portion of the thermally conductive inner tube 24, two supply fittings 30 for coolant (its flow shown by small arrows) being near to the dispensing end of inner tube 24 and a return fitting 32 for coolant being near to the feed tube elbow 28 end of inner tube 24, the flow of coolant traveling in a sealed area 38 between inner tube 24 and outer tube 26, with o-rings 34 creating the air-tight seal needed between inner tube 24 and outer tube 26, and ducting 36 creating turbulence in the coolant flow to enhance flow density and effect faster cooling of ingredients positioned within the thermally conductive inner tube 24.

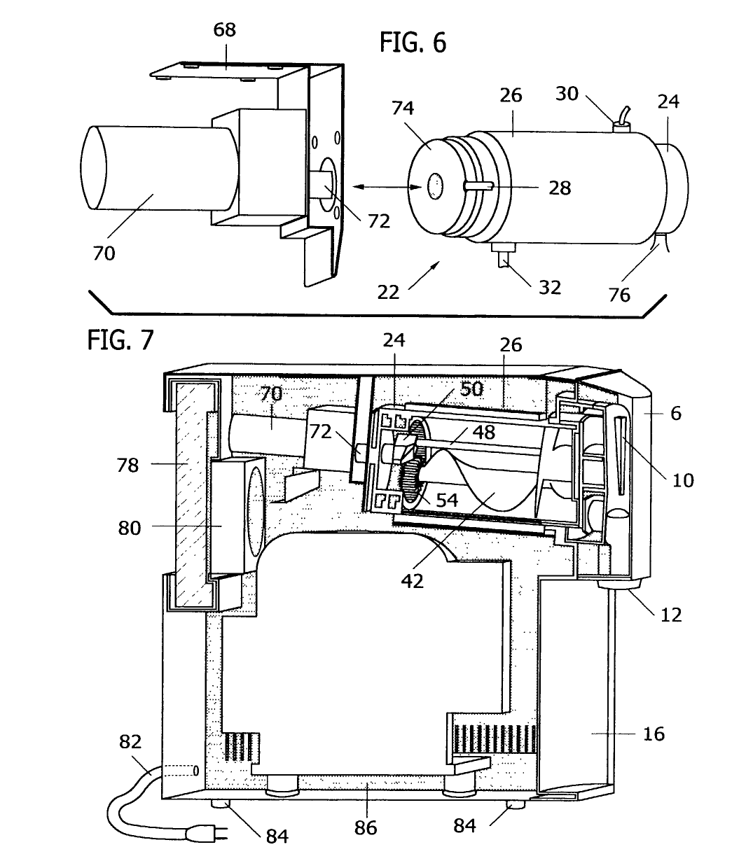

FIG. 3 shows the auger assembly 40 in the most preferred embodiment of present invention 2 with a main shaft 48 substantially parallel to an auger shaft 44 having an auger blade 42, a front wiper 46 on one end of the auger shaft 44 and a rear wiper 50 near to the opposing end of auger shaft 44, and with a gear 54 and drive shaft 52 used for rotational connection to an auger motor 70, shown in FIG. 6. The configuration shown in FIG. 2 permits auger assembly 40 to be disposed within freezing chamber 22 in a position to rotate about its longitudinal axis in a first direction while concurrently rotating about the longitudinal axis of freezing chamber 22 in a second direction that is substantially opposite to the first rotational direction, to assist in the creation of a rapidly frozen food or beverage product (not shown), typically within a time period of less than 15 minutes.

FIGS. 4 and 5 show the dispensing head assembly 10 of the most preferred embodiment of present invention 2 having a front portion 56 and a rear portion 58, with a pattern cap 12 having a dispensing opening 60 extending below the front portion of dispensing head assembly 10. FIG. 5 also shows the preferred embodiment of dispensing head assembly 10 having a centrally positioned shut-off member 62 secured against the rear surface of front dispensing head portion 56 by a seal plate 64 and a seal ring 66.

FIG. 6 shows the freezing chamber 22 and auger motor 70 of the most preferred embodiment of present invention 2, with a motor bracket 68 connected to auger motor 70 that has an opening allowing a drive shaft adapter 72 to extend beyond the downwardly extending portion of motor bracket 68 and connect to the auger assembly drive shaft 52 within the inner tube 24 of freezing chamber 22. The end cap 74 attached to the end of freezing chamber 22 that is adjacent to feed tube elbow 28, has a central aperture 186 for connection of adapter 72 to the auger assembly drive shaft 52. FIG. 6 also shows outer tube 26 surrounding inner tube 24, with one coolant supply fitting 30 and coolant return fitting 32 being positioned for circulation of coolant (the direction of flow being shown by small arrows in FIG. 2) within the sealed area 38 (shown in FIG. 2) between thermally conductive inner tube 24 and non-conductive outer tube 26. Further, FIG. 6 shows a thermistor 76 connected to the thermally conductive inner tube 24 of freezing chamber 22 for temperature measurement.

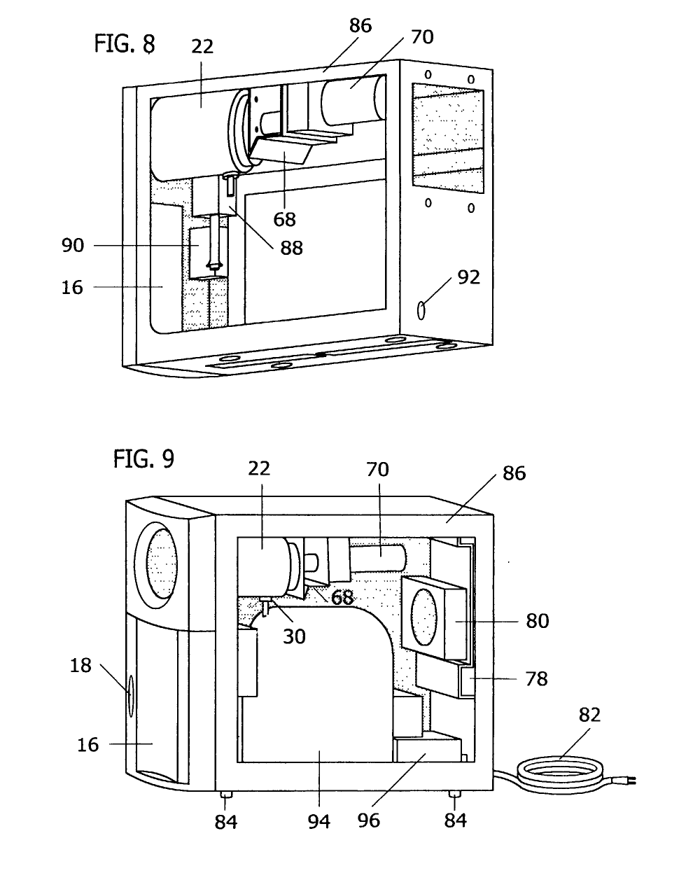

FIGS. 7-11 show the most preferred embodiment of the present invention having a chassis 86 and freezing chamber 22 supported within chassis 86. FIG. 7 also shows front cover 6 positioned over dispensing head assembly 10, and a condenser 78 and a fan 80 located within chassis 86 near to auger motor 70. FIG. 7 further shows auger assembly 40 comprising main shaft 48, auger blade 42, gear 54, and rear wiper 50 being positioned within freezing chamber 22, vent openings 178 near to the bottom of chassis 86 to assist fan 80 in dissipating heat from chassis 86, and a power cord 82. FIG. 8 shows freezing chamber 22 supported within chassis 86 and connected to auger motor 70, with auger motor 70 being supported within chassis 86 by motor bracket 68. FIG. 8 also shows a solenoid 88 secured within the front portion of chassis 86, adjacent to freezing chamber 22, dispensing recess 16 being connected to the front of chassis 86, and a solenoid control 90 positioned through chassis 86 below solenoid 88 and adjacent to dispensing recess 16. The control panel 18 shown in FIG. I is electrically connected through chassis 86 to solenoid control 90. FIG. 8 further shows an opening 92 in the rear lower portion of chassis 86 for connection of power cord 82.

FIG. 9 shows freezing chamber 22 supported within chassis 86 and connected to auger motor 70, with auger motor being connected to chassis 86 through use of motor bracket 68. FIG. 9 also shows a compressor 94 secured within chassis 86 below freezing chamber 22 with return coolant fitting 32 attaching freezing chamber 22 to compressor 94. FIG. 9 further shows a power cord 82 being connected through chassis 86 to a transformer 96, multiple feet 84 attached to the bottom surface of chassis 86, and fan 80 and condenser 78 positioned within chassis 86 above transformer 96 and adjacent to auger motor 70. Dispensing recess 16 and control panel 18 are both connected to the front portion of chassis 86. The number of feet 84 used is not critical, nor is their configuration or the materials from which they are made. However, it is contemplated for feet 84 to be made from a high friction material, such as rubber.

FIG. 10 shows compressor 94 mounted within chassis 86 of the most preferred embodiment of present invention 2, fan 80 and condenser 78 mounted within the upper rear portion of chassis 86, a power cord 82 attached through chassis 86 for electrical connection to a remote power supply (not shown), a printed circuit board 172 positioned within chassis 86 adjacent to compressor 94, solenoid control 90 secured through chassis 86 adjacent to printed circuit board 172 for connection to the control panel 18 shown in FIG. 1, and solenoid 88 secured within chassis 86 above solenoid control 90.

FIG. 11 shows the preferred embodiment of the present invention having compressor 94 mounted within chassis 86, fan 80 and condenser 78 mounted within the upper rear portion of chassis 86, solenoid 88 and solenoid control 90 being mounted within the front portion of chassis 86, and supply tubing 100 configured for transfer of non frozen consumable ingredients (not shown) and being connected between receptacle 8 and the inner tube 24 within freezing chamber 22. FIG. 11 also shows auger motor 70 being connected to chassis 86 through use of motor bracket 68.

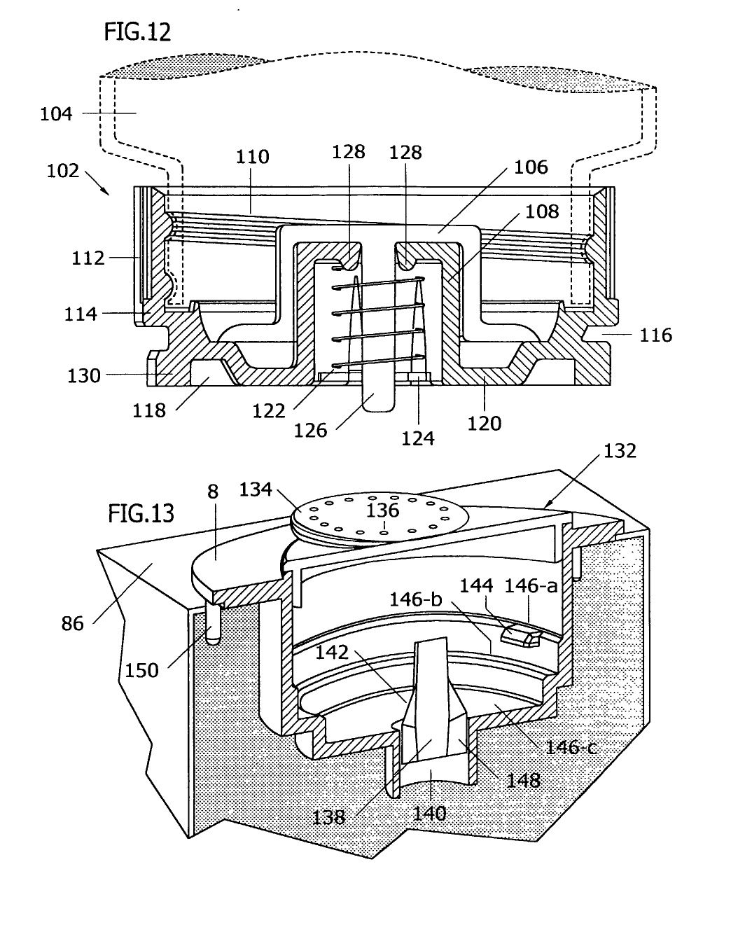

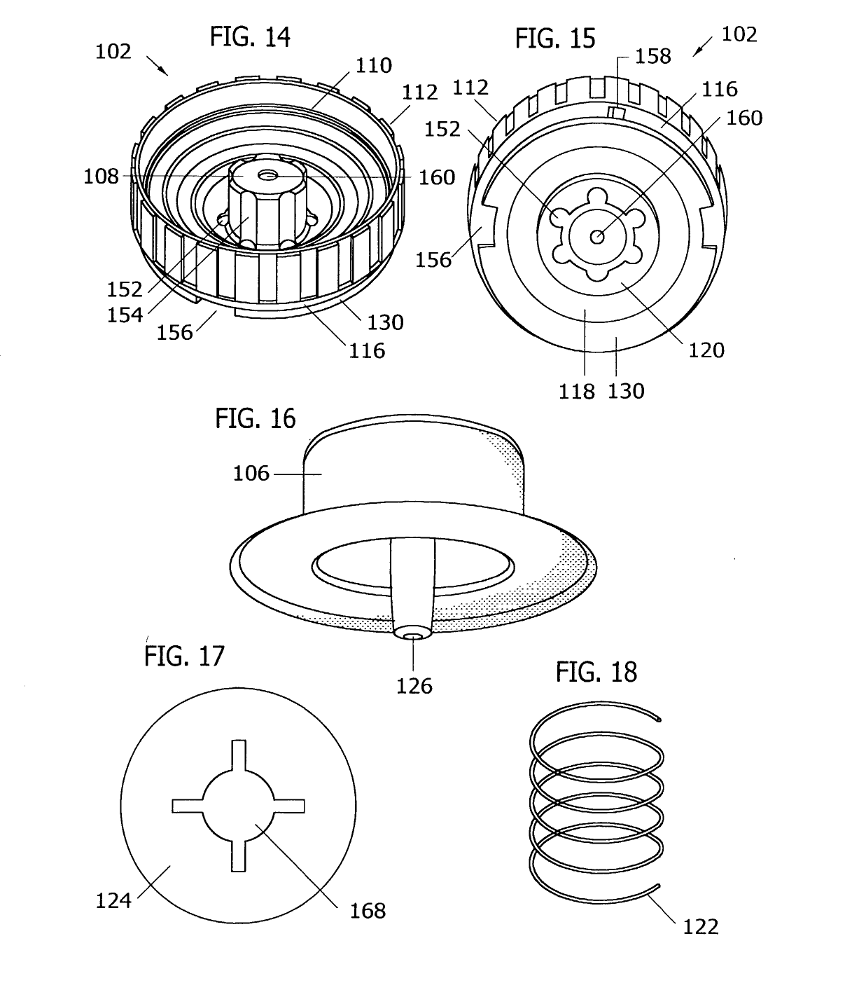

FIG. 12 shows the most preferred embodiment of the present invention dispensing bottle cap assembly 102 having a bottle cap member 114 connected around the neck of an inverted holding container 104. FIG. 12 shows bottle cap member 114 having an arcuate open upper end and spiral threads 110, on its inside surface near to its upper open end, that are configured for connection to a complementary pattern of threads (not shown) on the type of holding container 104 intended for use with dispensing bottle cap assembly 102 and from which a quantity of fluid or dry material (not shown) would be transferred. FIG. 12 also shows bottle cap member 114 having a substantially sealed end in a position opposed from its open upper end, of which an upwardly depending spring housing 108 is an important part. The most preferred embodiment of dispensing bottle cap assembly 102 further has stepped interior walls with obtuse angles 190 between each riser and the next adjacent horizontally extending surface below. The openings in the substantially sealed end of bottle cap member 114, which are not visible in FIG. 12, include a plurality of small holes, shown by the number 152 in FIGS. 14 and 15, which are spaced apart from one another and positioned around the base of spring housing 108, the central opening through the top surface of spring housing 108 and through which the activation pin 126 of valve closure member 106 is inserted during material transfer use, shown in FIG. 14 by the number 160, and the vertically extending slots 154 each having one small hole 152 at its lower end. Spring housing 108 is hollow and substantially cylindrical in configuration with a small downwardly depending circular ridge 128 on its inside upper surface, adjacent to central opening 160. Circular ridge 128 maintains the upper end of spring 122 in a substantially centered position within spring housing 108 during material transfer use. FIG. 12 further shows spring housing 108 substantially centered within the sealed end of bottle cap member 114, the central bottom surface around spring housing 108 being identified by the number 120, and an outer bottom rim 130 of bottle cap assembly 102 being separated from central bottom surface 120 by a circular bottom channel 118. Bottom rim 130 is also separated from the ribbed outer surface 112 on the upper portion of bottle cap member 114 by a circular side channel 116. Two opposing notches 156, not shown in FIG. 12 but illustrated in FIG. 15, are located through bottom rim 130. Notches 156 are configured and dimensioned to permit entry of the substantially rectangular protrusion 144 into side channel 116 so that locked engagement between dispensing bottle cap assembly 102 and receptacle 8 can be achieved when dispensing bottle cap assembly 102 is rotated relative to receptacle 8 and rectangular protrusion 144 no longer remains positioned near to either notch 156. Although not shown in FIG. 12, but shown in FIG. 15, bottle cap assembly 102 has a stop 158 positioned within side channel 116 centrally between notches 156. Thus, when dispensing bottle cap assembly 102 is rotated relative to receptacle 8 so that rectangular protrusion 144 engages stop 158, bottle cap assembly 102 and receptacle 8 are in a fully locked position relative to one another, whereby hands-free ingredient transfer to inner tube 24 is possible.

FIG. 12 also shows a valve closure member 106 positioned against the upper surface of spring housing 108, and in close proximity to the outside side surfaces of spring housing 108. Thus, spring housing 108 performs the function of a valve seat for valve closure member 106. FIG. 12 further shows valve closure member 106 having an outwardly extending lower flange with a downwardly arcuate outer edge that engages the upper surface of one of the risers in the stepped interior wall of bottle cap member 114. In addition, FIG. 12 shows an activation pin 126 downwardly depending from the inside central surface of valve closure member 106 with its distal end being inserted through and connected to a disk-like spring nut 124. During its engagement with spring housing 108, activation pin 126 extends through the central opening 160 in the top surface of spring housing 108, central opening 160 being more clearly revealed in FIGS. 14 and 15. FIG. 12 also shows activation pin 126 centered within a spring 122, with spring 122 extending between disk-like spring nut 124 and circular ridge 128. Spring 122 biases valve closure member 106 into its closed position against the top surface of spring housing 108, until bottle cap assembly 102 is moved longitudinally into contact with receptacle 8 whereby the tapering upper surfaces 142 of spring nut engagement member 138, as shown in FIG. 13, becomes partially inserted through the cutout pattern 168 in disk-like spring nut 124, shown in FIG. 17, and the top of spring nut engagement member 138 is permitted by disk-like spring nut 124 and spring 122 to push sufficiently against the tip of activation pin 126 to lift valve closure member 106 a fractional distance away from the top surface of spring housing 108. The compressed energy in spring 122 then causes valve closure member 106 to return to its closed position against spring housing 108, as soon as dispensing bottle cap assembly 102 is removed from receptacle 8. The number of coils present in spring 122 is not critical, nor is the thickness dimension of disk-like spring nut 124 as long as each can effectively perform the function for which it was designed. Also, the diameter of the material used for spring 122 can vary in different applications. The diameter of spring housing 108 is also variable, but must be sufficiently large to allow ample clearance for movement of disk-like spring nut 124 and spring 122 within its hollow interior. The diameters of activation pin 126 and the central opening 160 in the upper surface of spring housing 108 can also vary in size, as long as the diameter of central opening 160 remains sufficiently large to allow easy movement of activation pin 126 therethrough without undue friction and wear. The number, size, and configuration of spiral threads 110 can also vary, as long as they provide complementary engagement with threads (not shown) on the outside neck surface of holding container 104. The thickness is valve closure member 106 is also not critical, as long as it has a minimum thickness dimension that allows it sufficient rigidity to permit material flow without the material of valve closure member 106 buckling or folding under the weight of the dry or liquid substance stored in holding container 104 as it begins to flow. Further, the pattern in the ribbed outer surface 8 of bottle cap member 114 is not critical, and needs only to provide an easily-gripped surface for the hand of the person attempting to connect it to holding container 104. The thickness dimension of the material used for bottle cap member 114 should provide for a sturdy construction of bottle cap member 114. However, for cost-effective manufacturing the thickness of bottle cap member 114 should not be increased above or below the levels at which an appropriate benefit is no longer derived.

Although material used for manufacture can vary, it is contemplated for bottle cap member 114 in the most preferred embodiment of bottle cap assembly 102 to be made from plastic materials and have a unitary molded construction. Valve closure member 106 in the most preferred embodiment can be made from the same plastic material used for bottle cap member 114, or from a different material. For extended, trouble-free use, it is also contemplated for valve closure member 106 to have a unitary molded construction. It is further contemplated in the most preferred embodiment of present invention 2 for coil spring 122 to be made from non-corroding, non-toxic materials, such as stainless steel, and for disk-like spring nut 124 to be made from either plastic or metal materials. Since it is intended for food or ingestible liquids to be transferred from holding container 104 into receptacle 8, all materials anticipated to be in contact with product ingredients should be non-reactive and non-toxic. The size of holding container 104 relative to dispensing bottle cap assembly 102 is not critical, and does not have to be limited to that shown in FIG. 12. However, when hands-free transfer of material from holding container 104 to receptacle 8 is desired once dispensing bottle cap assembly 102 is locked in relation to receptacle 8, the shape of any holding container 104 connected to bottle cap member 114 must allow it to be inverted in a substantially symmetrical position over receptacle 8 for proper balance. Since it is contemplated for use with edible products, dispensing bottle cap assembly 102 should be made from materials that are easily cleaned and sanitized, with recyclable materials being employed when their use is cost-effective.

FIG. 13 shows the preferred embodiment of targeted receptacle 8 in present invention 2, which is contemplated for connection with dispensing bottle cap assembly 102. Receptacle 8 is secured within the upper surface of chassis 86. The size of receptacle 8 relative to chassis 86 is not critical, and does not have to be limited to that shown in FIG. 13. In addition, connection of receptacle 8 to chassis 86 should not be limited to the upper surface of chassis 86, and can be connected to a side surface of chassis 86, as long as discharge opening 140 is placed in a superior position relative to field tube elbow 28 on freezing chamber 22 so that gravity-assisted flow can be used to introduce ingredients (not shown) into inner tube 24 prior to freezing. FIG. 13 shows receptacle 8 being substantially cylindrical, with an outwardly extending upper flange adjacent to its top open end and opposing attachment pins 150 downwardly depending from the lower surface of the upper flange. The radially extending flange of receptacle 8 provides a connection means for attachment of receptacle 8 to chassis 86, as well as a connection means for hinged operation of a dust cap 132 over the top open end of receptacle 8 between periods of ingredient transfer. It is not critical for attachment pins 150 to be used for the connection of receptacle 8 to chassis 86, and any secure means can be used that allows receptacle 8 to remain stationary relative to chassis 86 when a bayonet turn is applied to dispensing bottle cap assembly 102 to lock it in place against the interior surface of receptacle 8. Also, when attachment pins 150 are used, they are not limited in size, configuration, or number to the two opposing attachment pins 150 shown in FIG. 13. In the most preferred embodiment of bottle cap assembly 102 used in present invention 2, it is contemplated for approximately six or seven attachment pins 150 to be employed. FIG. 13 also shows receptacle 8 having a top open end and a hollow interior with several stepped interior surfaces 146a-c decreasing in diameter toward its bottom end, with a substantially rectangular-shaped protrusion 144 inwardly depending from the inside wall surface of the receptacle 8 between the uppermost stepped interior surface 146a and the middle stepped interior surface 146b. Although the most preferred embodiment of the present invention bottle cap assembly 102 would have a single protrusion 144 within receptacle 8 for more cost-effective manufacture, it is also considered to be within the scope of bottle cap assembly 102 to have more than one protrusion 144. FIG. 13 further shows receptacle 8 having a discharge opening 140 centrally within its bottom end and a spring nut engagement member 138 permanently mounted within discharge opening 140, with the middle and lower portions of spring nut engagement member 138 having several spaced-apart flukes 148 radially extending from its outside surface and each fluke 148 ending in an upwardly tapering surface 142. The configuration of upwardly tapering surface 142 limits the type of dispensing bottle cap assembly 102 that can be locked within receptacle 8 and initiate material transfer through discharge opening 140, to a dispensing bottle cap assembly 102 containing a spring nut 124 with a cutout pattern 168 that complements upwardly tapering surface 142. Should upwardly tapering surface 142 not be able to become partially inserted with cutout pattern 168 prior to a locking bayonet turn being applied to bottle cap assembly 102 to lock it within receptacle 8, as the bayonet turn is applied the spring nut engagement member 138 will not advance sufficiently forward within spring housing 108 to contact the tip of actuation pin 126 and cause valve closure member 106 to be lifted away from the upper surface of spring housing 108, and ingredient flow into inner tube 24 will not occur. Thus, bottle cap assembly 102, in addition to providing spill-free transfer, can also be used to limit the source of ingredients conveniently transferred into inner tube 24 for freezing. The number of flukes 148 on spring nut engagement member 138 is not critical, but should not be so numerous as to impede the flow of material through discharge opening 140. In the most preferred embodiment of bottle cap assembly 102 it is contemplated for four flukes 148 to be employed, with the upper tapering surface 142 of each fluke 148 being aligned to engage a different one of the arm members in the X-shaped opening 168 of disk-like spring nut 124. It is contemplated that spring nut engagement member 138 would be permanently secured within the discharge opening 140 in the bottom of receptacle 8, where flukes 148 would allow easy and unimpeded flow of ingredients through discharge opening 140. It is also contemplated that spring nut engagement member 138 would be manufactured from the same material used make receptacle 8, and in the most preferred embodiment spring nut engagement member 138 and receptacle 8 would be made as a single unit through molded construction.

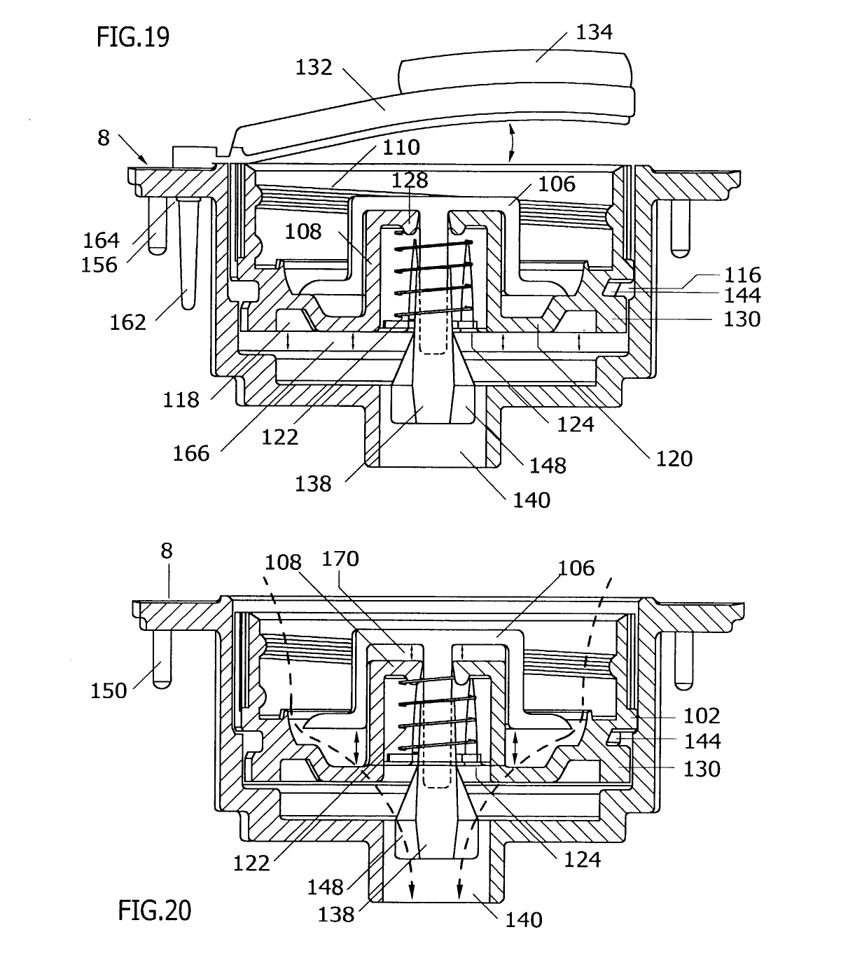

FIG. 13 further shows a dust cap 132 sealing the upper open end of receptacle 8 between ingredient transfer uses. The main body of dust cap 132 is in a position raised above the upper flange of receptacle 8, with its lower rim 174 extending downwardly a short distance within the top open end of receptacle 8. The hinged end of dust cap 132 that is shown in FIG. 19 is not visible in FIG. 13, and in the most preferred embodiment of present invention bottle cap assembly 102 the hinged end of dust cap 132 would comprise a single attachment post 162, a concave hinge member 176, and a retaining ring 164 on attachment post 162 near to hinge member 176. Attachment post 162 securely connects the rearward end of dust cap 132 through an attachment hole in the upper flange of receptacle 8, which remains hidden from view in FIG. 13. The diameter of such an attachment hole would correspond to the dimension required for insertion of attachment post 162 to the depth needed for proper seating of lower rim 174 within the top open end of receptacle 8. Attachment post 162 and concave hinge member 176 allow the main body of dust cap 132 to be rotated upwardly away from receptacle 8 prior to and during ingredient transfer, and subsequently lowered for renewed engagement with the top open end of receptacle 8 after ingredient transfer. A retaining ring 164 helps to prevent attachment post 162 from being inadvertently removed from the attachment hole in the upper flange of receptacle 8 while the lower rim 174 of dust cap 132 is being inserted into and removed from the top open end of receptacle 8. Concave hinge member 176 allows the main body of dust cap 132, raised portion 134, and lower rim 174 to be rotated as a unit upwardly away from the top open end of receptacle 8, so that holding container 104 connected by threaded attachment to bottle cap assembly 102 can be placed into locking engagement with receptacle 8 for ingredient transfer. FIG. 13 shows the end of dust cap 132 remote from attachment post 162 having a front raised portion 134 that improves the grip of an operator's hand on dust cap 132 during removal of dust cap 132 from the upper opening in receptacle 8. The configuration of front raised portion 134 can be any shape that is aesthetically pleasing and easily manipulated by an operator's hand. FIG. 13 also shows a plurality of raised circular protrusions 136 on the top surface of front raised portion 134. Although raised circular protrusions 136 are mainly decorative, they can also be configured to assist in an improved operator grip for easy lifting of dust cap 132 away from receptacle 8 or replacing dust cap 132 within the upper opening on receptacle 8 between ingredient transfer use. In the most preferred embodiment of bottle cap assembly 102, it is not contemplated for raised portion 134 to be separable from the remainder of dust cap 132. Although not limited thereto, in the most preferred embodiments of the present invention the entire dust cap 132, or at least the main body of dust cap 132, raised portion 134, and lower rim 176 would be made from a flexible material such as plastic or rubber. Although FIG. 13 shows front raised portion 134 having a substantially circular configuration, it is considered to be within the scope of the present invention for any shape to be used that is aesthetically pleasing and easily manipulated by an operator's hand. Further, in contrast to the raised circular protrusions 136 shown in FIG. 13, FIG. 19 shows the top surface of front raised portion 134 having no surface decoration. Thus, surface decoration on raised portion 134 is considered to be merely a matter of design choice. Since chassis 86 has a balanced and stable configuration, hands-free ingredient transfer into freezing chamber 22 can occur after dispensing bottle cap assembly 102 is locked into receptacle 8 with a bayonet turn.

FIGS. 14 and 15 show the most preferred embodiment of the present invention bottle cap assembly 102 having a substantially cylindrical configuration, an arcuate open upper end, and a central spring housing 108 upwardly depending from its lower substantially sealed end. Bottle cap assembly 102 has ribbed outer surface 112 adjacent to its open upper end and an inner surface with spiral threads 110. FIGS. 14 and 15 also show a side channel 116 adjacent to the lower end of bottle cap assembly 102, an outer bottom rim 130 adjacent to and below side channel 116, and a notch 156 through outer bottom rim 130. In addition, FIG. 14 shows spring housing 108 having a central opening 160 through its top surface, several spaced-apart and vertically-extending slots 154 through its outside surface, and each slot 154 communicating at its lower end with a small hole 152 at the base of spring housing 108. The configuration of ribbed outer surface 112 is not critical, and not limited to that shown in FIGS. 14 and 15. However, the configuration of ribbed outer surface 112 must be one that is easily gripped by an adult human hand for prompt attachment or removal of bottle cap assembly 102 from holding container 104. Also, spiral threads 110 can have any configuration that securely connects bottle cap assembly 102 to the neck of a targeted holding container 104 and provides a leak-proof connection therebetween. The notches 156 through outer bottom rim 130 must be dimensioned and configured for insertion of substantially rectangular protrusion 144 on the inside surface of receptacle 8, so that as bottle cap assembly 102 is longitudinally moved into contact with receptacle 8, and a bayonet turn is applied, side channel 116 can be made to move around rectangular protrusion 144 until rectangular protrusion 144 makes contact with the stop 158 within side channel 116, that is shown in FIG. 15 centrally positioned between opposing notches 156. Although the most preferred embodiment of bottle cap assembly 102 would have a single stop 158 within side channel 16 of bottle cap member 114 for more cost-effective manufacture, it is also considered to be within the scope of bottle cap assembly 102 to have more than one stop 158, more than two notches 156, or more than one protrusion 144. The size of central opening 160 should be sufficient to allow easy movement therethrough of activation pin 126 for prompt lifting of valve closure member 106 away from the outside surface spring housing 108 once bottle cap assembly 102 is brought longitudinally into contact with receptacle 8. Further, the number and dimension of vertically-extending slots 154 and small holes 152 through spring housing 108 are not critical, although for most applications it would be preferred to have approximately four to six vertically-extending slots 154 and small holes 152 to allow prompt smooth ingredient flow from holding container 104 through receptacle 8 and into the inner tube 24 of freezing chamber 22. FIG. 15 also shows bottle cap assembly 102 having a circular bottom channel 118, a central bottom surface 120 below spring housing 108, with the small holes 152 at the base of spring housing 108 extending through central bottom surface 120. In addition, FIG. 15 shows the tip of the activation pin 126 that is attached to spring-biased valve closure member 106 centrally visible through central bottom surface 120, the disk-like spring nut 124 visible around the tip of activation pin 126, and small holes 152 visible around disk-like spring nut 124. When valve closure member 106 is lifted from the top surface of spring housing 108, dry or liquid material (not shown) from holding container 104 is allowed to flow through small holes 152, beyond disk-like spring nut 124, and into receptacle 8. Although not limited thereto, in the most preferred embodiment it is contemplated for bottle cap assembly 102 to be formed as a single rigid unit from molded construction, and made from plastic materials.

FIG. 16 shows the most preferred embodiment of the present invention spring-biased valve closure member 106 having a substantially cylindrical main body and a hollow interior, with an upper closed end and a bottom open end. FIG. 16 also shows the outwardly extending lower flange around the open end of its main body having a downwardly arcuate outer edge. In addition, FIG. 16 shows central activation pin 126 downwardly depending from the interior surface of the upper closed end of the main body of valve closure member 106, in a position extending below the plane of its outer edge. Thus, when valve closure member 106 is seated upon spring housing 108 with its activation pin 126 inserted through central opening 160 in the upper end of spring housing 108, and a spring 122 is connected between the upper interior surface of spring housing 108 and a disk-like spring nut 124 having a particular cutout pattern 168 with spring nut 124 positioned adjacent to the lower open end of spring housing 108, only a receptacle 8 having a spring nut engagement member 138 with tapering upper surfaces 142 allowing for partial insertion through cutout pattern 168 will be able to reach the tip of activation pin 126 and lift valve closure member 106 from its spring housing 108 valve seat to initiate transfer of ingredients (not shown) into receptacle 8 secured within chassis 86. In the most preferred embodiment of bottle cap assembly 102, valve closure member 106 would be formed as a single rigid unit from molded construction, and made from plastic materials. While it is contemplated that the same plastic material used for bottle cap member 114 could be used in valve closure member 106, the thickness dimension of valve closure member 106 would typically be less than that the thickness dimension of most surfaces of bottle cap member 114. However, the thickness dimension of valve closure member 106 should be sufficient so that the flow of ingredients from holding container 104 across downwardly arcuate outer edge of its flange does not cause the outer edge to buckle, fold, or otherwise be subject to a change in configuration that would obstruct proper reseating of valve closure member 106 against spring housing 108 after ingredient transfer.

FIG. 17 shows the most preferred embodiment of the present invention spring nut 124 having a disk-like configuration and a central cutout pattern 168 comprising a round hole portion intersecting with an X-shaped opening wherein the length of each of the two arm members of the X-shaped opening is approximately twice that of the diameter dimension of the round hole portion. The configuration of cutout pattern 168 is not critical and other patterns are considered to also be within the scope of the present invention. However, cutout pattern 168 must complement the configuration of the upwardly tapering surfaces 142 of spring nut engagement member 138 so that as bottle cap assembly 102 is moved longitudinally toward receptacle 8 and comes very near to receptacle 8, upwardly tapering surfaces 142 become partially inserted within cutout pattern 168, and so that when bottle cap assembly 102 is finally placed in full contact with receptacle 8, the top of spring nut engagement member 138 will have made sufficient contact with the tip of activation pin 126 to fractionally raise it and thereby lift valve closure member 106 a short distance away from the top outside surface of spring housing 108 to initiate material flow downwardly past the outer edge of valve closure member 106. Broken lines in FIG. 20 show the direction of material flow anticipated around the downwardly arcuate outer edge of valve closure member 106 in the most preferred embodiment of bottle cap assembly 102.

FIG. 18 shows the most preferred embodiment of the coil spring 122 used in the present invention bottle cap assembly 102, with spring 122 having a substantially uniform diameter dimension and uniformly spaced apart coils. During use of spring 122 within dispensing bottle cap assembly 102, activation pin 126 centered within spring 122, with spring 122 extending between disk-like spring nut 124 and the circular ridge 128 on the top inside surface of spring housing 108. The number of coils present in spring 122, and the material from which spring 122 is made, are not critical as long as spring 122 can properly bias valve closure member 106 into its fully closed position against the top surface of spring housing 108. Although the diameter of spring housing 108 can vary, it must allow ample clearance for unrestricted movement of the spring 122 chosen for use within its hollow interior. Further, the diameter of spring 122 can vary in different applications, as long as disk-like spring nut 124 is also correspondingly sized to engage spring 22, maintain it within spring housing 108, and move spring 122 the correct longitudinal distance within spring housing 108 after bottle cap member 114 is finally in full contact with receptacle 8 so that the top of spring nut engagement member is 138 comes in contact with the tip of activation pin 126 with sufficient force to compress spring 122 and lift valve closure member 106 the necessary distance above spring housing 108 to initiate ingredient flow into receptacle 8. After the needed amount of ingredient transfer is complete, bottle cap assembly 102 is separated from receptacle 8, and the upper surfaces 142 of spring nut engagement member 138 are no longer in contact with the tip of activation pin 126, the stored compression energy in spring 122 causes valve closure member 106 to again be biased in a closed position against the outside surface of spring housing 108. In the most preferred embodiment of bottle cap assembly 102, it is not contemplated for more than a fractional movement of valve closure member 106 to take place, for example but not limited to a distance of one-sixteenths of an inch, before it is sufficiently unseated from spring housing 108 to initiate material flow around outer edge 34.

FIGS. 19 and 20 respectively show dispensing bottle cap assembly 102 in partially assembled and fully assembled condition. FIG. 19 shows dispensing bottle cap assembly 102 partially inserted within receptacle 8 prior to full contact with the bottom inside surface of receptacle 8, illustrated by the gap 166 and small arrows between the central bottom surface 120 of bottle cap member 114 and the bottom inside surface of receptacle 8. As also shown in FIG. 19, valve closure member 106 remains in a closed position against the top surface of spring housing 108 so as to prevent ingredient flow into receptacle 8. In contrast, FIG. 20 shows dispensing bottle cap assembly 102 fully inserted within receptacle 8, after the bayonet turn has been made that locks protrusion 144 within channel 116 to secure dispensing bottle cap assembly 102 to receptacle 8, with the central bottom surface 120 of bottle cap assembly 102 being in full contact with the bottom inside surface of receptacle 8, as illustrated by the gaps 170 and small arrows between valve closure member 106 and the top surface of spring housing 108, as well as between the inside bottom surface of bottle cap assembly 102 and the downwardly curving outer edge of the flange that is radially depending around the lower open end of valve closure member 106. In such a position, FIG. 20 shows valve closure member 106 in an open configuration that would allow ingredients (not shown) to flow from an inverted holding container 104 attached to dispensing bottle cap assembly 102 (as shown in FIG. 12), all the way through receptacle 8 and into the inner tube 24 of freezing chamber 22. The amount of separation in FIG. 20 between outer edge 34 and the inside bottom surface of bottle cap assembly 102 is enlarged for illustrative purposes. FIG. 19 further shows dust cap 132 in a partially opened position above the upper opening in receptacle 8, with double-headed arrows showing that dust cap 132 can be moved in both upward and downward directions relative to receptacle 8 when required. Dust cap 132 is employed for sealing the upper opening in receptacle 8 between uses of receptacle 8 for ingredient transfer, with dust cap 132 being attached to the upper flange of receptacle 8 through use of an attachment post 162. A ring 164 would keep attachment post 162 from being inadvertently removed from the upper flange in receptacle 8 while in use. A concave hinge member 176 allows the main body of dust cap 132, raised portion 134, and lower rim 174 to be rotated upwardly as a unit away from the top end opening in receptacle 8, so as not to adversely interfere with holding container 104 while it is connected by threaded attachment to a bottle cap member 114 in locked engagement with receptacle 8. Manufacture of bottle cap member 114, valve closure member 106, disk-like spring nut 124, and receptacle 8, could each be accomplished through unitary construction from molded plastic. Spring 122 is not limited to any one type of material, however, it should have sturdy and durable construction for trouble-free repeat use over an extended period of time. In the most preferred embodiment of present invention 2, the spring nut engagement member 138 would be molded in a fixed position within discharge opening 140 as part of receptacle 8. Dispensing bottle cap assembly 102 would be placed into its usable form by inserting valve closure member 106 within bottle cap member 114 so that activation pin 126 extends through central aperture 74 in spring housing 108. A coil spring 122 would be placed within the hollow interior of spring housing 108 either before or after activation pin 126 is inserted therethrough, and then prevented from being withdrawn from the open end of spring housing 108 by disk-like spring nut 124. When valve closure member 106 is in its fully closed position against the top surface of spring housing 108, and preventing communication between the upper portion of bottle cap member and small holes 74 around the base of spring housing 108, activation pin 126 would extend a small distance below the central bottom surface 120 of bottle cap member 114. No further assembly would be required to place receptacle 8 into its usable condition, except that a dust cap 132 made from a unitary molded construction and flexible material can be placed within the upper opening of receptacle to keep unwanted objects from becoming deposited on the interior walls of receptacle 8 so that it does not require cleaning between uses.

Although not limited there to, most of the objects mounted within chassis 86 are done so with various types of screws (not shown), or bolts, nuts, and washers. Further, although not critical in the preferred embodiment, it is contemplated for tubing 100 in the most preferred embodiment of the present invention, connected between receptacle 8 and freezing chamber 22, to be flexible tygon tubing. For most efficient mixing of food product ingredients (not shown) within inner tube 24, it preferred that the inside surface of inner tube 24 be substantially smooth. One suggested material for inner tube 24 is stainless steel. Outer tube 26 can be made from non-thermally conductive materials, or comprise one or more layers of thermally insulating materials. It is also preferred that the surfaces of auger blade 42 be smooth. Cleaning solution (not shown) is also introduced into inner tube 24 via receptacle 8 for the automatic cleaning cycle using control panel 18. However, manual cleaning of auger assembly 40 can also be an alternative, by removal of cover 6, dispensing head assembly 10, and the end cap 74 from freezing chamber 22. Also, it is contemplated for auger assembly 40 to be made from components that are dishwasher safe. Further, when any automated cycle is complete, although not shown, the present invention can comprise any known means of audible or visual signaling, such as an LED light, to let a user know that the soft frozen product is ready for consumption. Although not limited thereto, an embodiment of present invention 2 with a housing 4 having a width dimension of approximately eight inches, a height dimension of approximately 16 inches, a depth dimension of less than eighteen inches, and weighing less than fifty pounds, would be able to produce approximately thirty ounces of frozen product with each cycle. The type of consumable product created with the present invention is only limited by one's imagination and can include frozen coffee, teas, adult drinks, slush beverages, milk shakes, frozen yogurt and yogurt based beverages, as well as soft serve ice cream and other soft frozen dessert concoctions. The present invention is low cost, takes up little space, and has easy maintenance. In addition to domestic use, it can also be used in convenience stores, gas stations, cafeterias, hospitals, offices, bars, and restaurants.

I claim:

1. A self-contained domestic food and beverage system for automatically preparing and dispensing soft ice cream products, slush drinks, and other soft frozen consumable products from unfrozen ingredients, said system comprising:
compact housing means adapted for domestic use;
ingredient introduction means;
product mixing means;
product freezing means;
product dispensing means;
product selection means;
power supply means; and
microprocessor means adapted for fully automated control of product mixing time, mixing speed, and cooling temperature for each cycle of use, said microprocessor means also being adapted for fully automated control of product dispensing, whereby after placement of unfrozen ingredients for a desired soft frozen consumer product into said ingredient introduction means and corresponding operator engagement of said product selection means, said microprocessor means automatically prepares and dispenses the desired soft frozen consumer product.

2. The system of claim 1 wherein said ingredient introduction means has a dispenser portion and a receptacle portion which must lock together prior to allowing any flow of unfrozen ingredients into said housing, so as to be spill-free.

3. The system of claim 1 wherein said ingredient introduction means is gravity assisted.

4. The system of claim 1 wherein said product freezing means comprises a thermally conductive inner tube, a non-conductive outer tube, and a sealed area between said inner tube and said outer tube that is adapted for coolant flow.

5. The system of claim 4 wherein said product freezing means further comprises coolant circulation means adapted for circulating sufficient coolant through said sealed area to rapidly and evenly cool said thermally conductive inner tube to temperatures appropriate for producing soft frozen consumable products.

6. The system of claim 1 wherein said product mixing means comprises a scraping device adapted for rotation within said freezing chamber.

7. The system of claim 6 wherein said scraping device comprises front and rear wipers.

8. The system of claim 1 wherein said product introduction means comprises a receptacle disposed through said housing means and a bottle cap assembly configured for locking connection to said receptacle in a manner that prevents ingredient flow until said bottle cap assembly is fully seated within said receptacle.

9. The system of claim 1 further comprising an automated cleaning cycle controlled by said microprocessor means and which is operator activated via said product selection means.

10. The system of claim 1 wherein said microprocessor means is adapted for stopping the cooling and mixing of soft frozen consumable products when said product mixing means encounters a predetermined level of torque.

11. A domestic food and beverage system for automatically preparing and dispensing soft ice cream products, slush drinks, and other partially soft frozen consumable products from unfrozen ingredients, said system comprising:
a housing;
a freezing chamber disposed within said housing;
ingredient introduction means adapted for transferring unfrozen consumable ingredients into said freezing chamber;
refrigeration means adapted for preparing a cooled consumable product within said freezing chamber;
product scraping means disposed within said freezing chamber and adapted for mixing partially frozen consumable product;
dispensing means adapted for transferring partially frozen consumable product from said freezing chamber;
microprocessor means adapted for automated control of consumable product mixing time, mixing speed, and cooling temperature;
power supply means adapted for providing electrical power for said microprocessor means; and
product selection means disposed through said housing means and adapted for operator hand manipulation.

12. The system of claim 11 wherein said refrigeration means comprises a thermally conductive inner tube, a non-conductive outer tube, and a sealed area between said inner tube and said outer tube adapted for coolant flow.

13. The system of claim 12 wherein said refrigeration means further comprises coolant circulation means adapted for circulating sufficient coolant through said sealed area to rapidly and evenly cool said thermally conductive inner tube to temperatures appropriate for producing soft frozen consumable products.

14. The system of claim 11 wherein said product scraping means comprises a scraping device adapted for rotation within said freezing chamber, said scraping device having front and rear wipers.

15. The system of claim 11 wherein said ingredient introduction means comprises a receptacle disposed through said housing means and a bottle cap assembly configured for locking connection to said receptacle in a manner that prevents ingredient flow until said bottle cap assembly is fully seated within said receptacle.

16. The system of claim 11 further comprising an automated cleaning cycle controlled by said microprocessor means and which is operator activated via said product selection means.

17. A portable domestic food and beverage system for automatically preparing and dispensing soft ice cream products, slush drinks, and other soft frozen consumable products from non-frozen ingredients, said system comprising:
a freezing chamber;
compact housing means adapted for domestic use;
scraping means;
refrigeration means;
product dispensing means;
ingredient introduction means;
product selection means;
power supply means; and
automatic control means wherein said housing means is disposed around said freezing chamber and said refrigeration means for self-contained operation.

18. The system of claim 17 wherein said scraping means is adapted for rotation within said freezing chamber, said ingredient introduction means is adapted for spill-free operation, and said housing means is self-contained and compact in design.

19. The system of claim 17 further comprising heat exhaust means adapted for dissipating excess heat from said housing means.

20. The system of claim 17 wherein said automatic control means is adapted for stopping the cooling and mixing of consumable products when said scraping means encounters a predetermined level of torque.
